(19) United States
(12) Patent Application Publication
(10) Pub. No.: US 2014/0089431 A1
(43) Pub. Date: Mar. 27, 2014

(54) INSTANT MESSAGING METHOD, TERMINAL, SERVER, AND SYSTEM

(71) Applicant: Tencent Technology (Shenzhen) Company Limited, Shenzhen (CN)

(72) Inventors: Qian JIANG, Shenzhen (CN); Wen Long Luo, Shenzhen (CN); Tian Chen, Shenzhen (CN); Xiao Xiao, Shenzhen (CN)

(73) Assignee: Tencent Technology (Shenzhen) Company Limited, Shenzhen (CN)

(21) Appl. No.: 14/030,980

(22) Filed: Sep. 18, 2013

(30) Foreign Application Priority Data
Sep. 21, 2012 (CN) 201210360622.6

(51) Int. Cl. H04L 12/58

(52) U.S. Cl. CPC H04L 51/04
USPC 709/206

(57) ABSTRACT

The present disclosure discloses an instant messaging method, terminal, server and system. The method includes: a first instant messaging terminal transmitting a transfer request to a second instant messaging terminal, both terminals logged into the same instant messaging account; the second instant messaging terminal responding to the transfer request, transmitting a reply command accepting the transfer; after receiving the reply command, the first instant messaging terminal obtaining information of the current instant messaging session and transmitting the information to the second instant messaging terminal; the second instant messaging terminal setting an instant messaging session based on the received information. The present disclosure can facilitate effective transfer of an instant messaging session, thus allowing a user to easily continue the previous instant messaging session after switching to a different terminal.

### CROSS REFERENCE TO RELATED APPLICATION

This application claims the priority benefit of Chinese Patent Application No. 201210360622.6, filed on Sep. 21, 2012, the content of which is incorporated by reference herein in its entirety for all purposes.

### FIELD

This disclosure relates to messaging, and in particular, to an instant messaging method, terminal, server, and system.

### BACKGROUND

As Internet and terminal technology develops, a user can carry out instant messaging (IM) using an instant messaging applications on various types of terminals. When the user switches to a different terminal due to a change to his surroundings, the instant messaging session on the previously-used terminal may not be continued. Although current technologies can already allow a user to log into the same instant messaging account at multiple terminals, the user still has to reset the instant messaging session when the user switches terminals, for example, from a personal computer (PC) to a mobile phone when the user has to leave home due to an emergency. This is because the previous instant messaging session has already been terminated. For example, the user may need to re-open his friend's profile or virtual space that was being browsed previously or re-send a request for establishing a voice or video instant messaging session to restore the previous instant messaging connection. This can be hugely inconvenient for the user.

### SUMMARY

One of the technical problems that can be resolved by the embodiments of the present disclosure is to provide an instant messaging method, terminal, server, and system to allow a user to continue a previous instant messaging session after switching terminals.

In a first aspect of the disclosure, embodiments of an instant messaging method are provided. The method can include the following exemplary steps.

A first instant messaging terminal can transmit a transfer request to a second instant messaging terminal, both terminals logged into the same account.

The second instant messaging can respond to the transfer request, transmitting a transfer-accepting reply command.

The first instant messaging terminal can, after obtaining the reply command transmitted from the second instant messaging terminal, obtain current instant messaging session information and transmit the current instant messaging session information to the second instant messaging terminal.

The second instant messaging terminal can set an instant messaging session based on the current instant messaging session information.

Accordingly, in a second aspect of the disclosure, embodiments of a first instant messaging terminal are provided. The first instant messaging terminal can include the following exemplary modules.

A transfer request transmitting module can transmit a transfer request to a second instant messaging terminal, the first and second instant messaging terminals logged into the same instant messaging account.

A reply obtaining module can obtain a transfer-accepting reply command transmitted from the second instant messaging terminal.

A messaging transferring module can obtain current instant messaging session information and transmit the current instant messaging session information to the second instant messaging terminal to allow the second instant messaging terminal to set an instant messaging session based on the current instant messaging session information, when the reply obtaining module obtains the transfer-accepting reply command from the second instant messaging terminal.

Accordingly, in a third aspect of the disclosure, embodiments of a second instant messaging terminal are provided. The second instant messaging terminal can include the following exemplary modules.

A transfer request obtaining module can obtain a transfer request from a first instant messaging terminal, the first instant messaging terminal and the second instant messaging terminal logged into a same instant messaging account.

A transfer replying module can respond to the transfer request, transmitting to the first instant messaging terminal a transfer-accepting reply command.

A messaging session restoring module can obtain, from the first instant messaging terminal, current instant messaging session information and set an instant messaging session based on the current instant messaging session information.

Accordingly, in a fourth aspect of the disclosure, embodiments of a messaging server are provided. The messaging server can include the following exemplary modules.

A transfer request forwarding module can obtain a transfer request transmitted from a first instant messaging terminal to a second instant messaging terminal, the first instant messaging terminal and second instant messaging terminal logged into a same instant messaging account, and forward the transfer request to the second instant messaging terminal.

A reply forwarding module can obtain a transfer-accepting reply command transmitted from the second instant messaging terminal in response to the transfer request, and forward the reply command to the first instant messaging terminal.

A messaging session transferring module can obtain current instant messaging session information of the first instant messaging terminal transmitted from the first instant messaging terminal, and forward the current instant messaging session information to the second instant messaging terminal to allow the second instant messaging terminal to set an instant messaging session based on the current instant messaging session information.

Accordingly, in a fifth aspect of the disclosure, embodiments of an instant messaging system are provided. The instant messaging system can include, for example, an embodiment of the first instant messaging terminal in the second aspect of the disclosure and an embodiment of the second instant messaging terminal in the third aspect of the disclosure.

The first instant messaging terminal can transmit a transfer request to the second instant messaging terminal logged into the same instant messaging application and, after obtaining the transfer-accepting reply command transmitted from the second instant messaging terminal, transmit the current instant messaging session information to the second instant messaging terminal.

The second instant messaging terminal can obtain the transfer request transmitted from the first instant messaging terminal, transmit the transfer-accepting reply command to the first instant messaging terminal, obtain the current instant messaging session information of the first instant messaging terminal, and set the instant messaging session based on the current instant messaging session information.

The advantages of the present disclosure can include, for example, facilitating an effective transfer of an instant messaging session by transferring instant messaging session information from an originating terminal to a receiving terminal, thus allowing the user to conveniently continue the previous instant messaging session after switching terminal.

### BRIEF DESCRIPTION OF THE DRAWINGS

FIG. 1 is a flowchart illustrating the exemplary steps of an instant messaging method, according to a first embodiment of the disclosure.

FIG. 2 is a flowchart illustrating the exemplary steps in an instant messaging method, according to a second embodiment of the disclosure.

FIG. 3 is a flowchart illustrating exemplary steps in an instant messaging method, according to a third embodiment of the disclosure.

FIG. 4 is a block diagram illustrating the exemplary structure of a first instant messaging terminal, according to an embodiment of the disclosure.

FIG. 5 is a block diagram illustrating the exemplary structure of the second instant messaging terminal, according to an embodiment of the disclosure.

FIG. 6 is a block diagram illustrating the exemplary structure diagram of the messaging server, according to an embodiment of the disclosure.

FIG. 7 is a block diagram illustrating exemplary structure of an instant messaging system, according to an embodiment of the disclosure.

FIG. 8 is a block diagram illustrating an exemplary structure of the instant messaging system, according to another embodiment of the disclosure.

FIG. 9 illustrates exemplary common components of a computing system such as the terminals and servers in the various embodiments described below.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

This disclosure generally relates to transferring an instant messaging session or other types of live communication sessions from one terminal to another terminal in a seamless fashion so as to provide a continuous user experience on the different terminals. As referred hereinafter, terminals can be any electronic device capable of communicating with one or more other terminals over a computer network for transmitting and/or receiving data. Such devices can include, but are not limited to, PCs, Macs, desktop computers, laptop computers, tablet PCs, smartphones including iPhones, Android phones, Windows phones, and Blackberries, e-readers, in-car communication devices, televisions, gaming consoles and other consumer electronic devices with sufficient network capabilities. Furthermore, the terms “device” and “terminal” are interchangeable terminologies in this disclosure.

The terminals/devices in the embodiments discussed below can have installed on them and run a communication tool or application (the terms “tool” and “application” are interchangeable terminologies in this disclosure) for communicating with one or more other terminals/devices. The communication tool or application can, for example, be an instant messaging application (e.g., MSN messenger by Microsoft or QQ by Tencent) or any other types of messaging applications. In the embodiments described below, a terminal or device can be referred to as a first instant messaging terminal or a second instant messaging terminal, although it should be understood that the first and second instant messaging terminals are not necessarily terminals dedicated for the purpose of sending and receiving instant messages or other types of messages. That is, the first and second instant messaging terminals can be any devices such as those listed above. They can be general purpose devices (PCs, iPhones) or devices built for particular purposes, so long as they are capable of communicating with one or more other terminals through a communication application.

A user may be instant messaging his friend using an instant messaging application on his PC at home. The messages being sent and received can be in any format including, but not limited to, text, audio, and video. At some point during the messaging session, the user may have to leave his home PC and be on the go with only his smartphone. Typically, if he wants to continue messaging his friend, he has to open up the instant messaging application on his smartphone, find his friend, and start a new session. This process requires a number of steps and can be unfriendly to the user experience. Furthermore, the new messaging session starting on the smartphone does not display a record of the previous message exchanges from the messaging application on the PC. This makes it difficult for the user to refer back to the information in the previous messages. Embodiments of the present disclosure disclose methods and systems that cure these deficiencies of the existing technologies.

In particular, according to the embodiments, a first instant messaging terminal (e.g., the home PC from which the user has been instant messaging) can send a transfer request to a second instant messaging terminal (e.g., the smartphone on which messaging is to be continued) to transfer the instant messaging session to the second instant messaging terminal. The transfer request can be transmitted via the instant messaging application. The second instant messaging terminal can send a reply to the first instant messaging terminal, either rejecting or accepting the transfer request.

If the transfer request is accepted, the first instant messaging terminal can transmit information about the current instant messaging session (e.g., current instant messaging session information) to the second instant messaging terminal. This information can include, for example, information about the opposite terminal (e.g., opposite terminal information) with which the first instant messaging terminal has been messaging. The opposite terminal information can include an identification of the opposite terminal to be used by the second instant messaging terminal to locate and establish a connection with the opposite terminal. The current instant messaging session information can also include, for example, a record of part or all of the previously exchanged messages in the current session so that these messages can be displayed on the second instant messaging terminal once the session is transferred. Some or all information transmitted between the terminals can be via the same instant messaging application. That is, the two terminals can be logged into the same account of the instant messaging application prior to transferring an instant messaging session.

After receiving the current instant messaging information from the first instant messaging terminal, the second instant messaging terminal can restore the messaging session by, for example, establishing an instant messaging connection with the opposite terminal and display all the previous messages. This allows the user to continue messaging his friend as if he had never left his home PC.

In the various embodiments discussed below. The same terminal can be capable of transferring a messaging session to another terminal and accepting and receiving a session from another terminal. This allows the user to maintain one session for as long as he desires by transferring it back and forth among multiple terminals. Because the terminals may be running different versions of the same instant messaging application (or other types of communication applications) and/or the terminals may have a display screen with different sizes, information such as the current instant messaging terminal session information can be transmitted in a raw format and then automatically reformatted based on the hardware and software of the receiving terminal (e.g. the second instant messaging terminal).

As described in the embodiments below, in operation, the terminals (e.g., the first and second instant messaging terminal) can be connected to each other through a network. The network can be any computer network such as the Internet, a LAN, wide area network (WAN), cellular network, Wi-Fi network, and virtual private network (VPN).

In some embodiments, the terminals can connect to each other directly and communicate with each other without going through a server. For example, when the terminals can connect to each other directly when they are connected to the same network, (e.g., the same LAN or Wi-Fi spot) or when they are connected directly to each other through, for example, a Bluetooth or other types of wireless or wired connections. If the terminals cannot connect to each other directly, they can communicate through a messaging server (e.g., an instant messaging server such as a QQ server provided by Tencent for supporting the QQ instant messaging application). For example, when the first and second instant messaging terminals are connected to two different networks (e.g., LANs) or direct communication is block by a firewall, some or all of the communications between the first and second instant messaging terminals can be routed through a messaging server. In some embodiments, to determine whether two or more terminals can connect to each other directly, each of the terminals can upload their gateway device information to a server, which can then determine, based on the gateway device information, whether the terminals can connect to each other directly. The messaging server can also be a server hosting the instant messaging service.

In some embodiments, if the communication application is not in an active mode on a terminal (e.g., if the application is running in the background while another application is running in the foreground), the messaging server may first send a message (e.g., a push message) to the terminal to activate the communication application (e.g., move it to the foreground) before forwarding a request or information to the terminal. This can require the messaging server to obtain an operating status of the communication application on the terminal before forwarding any communications to the terminal.

The instant messaging terminals mentioned in the embodiments of the disclosure can be PCs (personal computer), mobile phones, tablet PCs, smartphones, e-readers, laptop computers, in-car terminals, or any network-enabled devices.

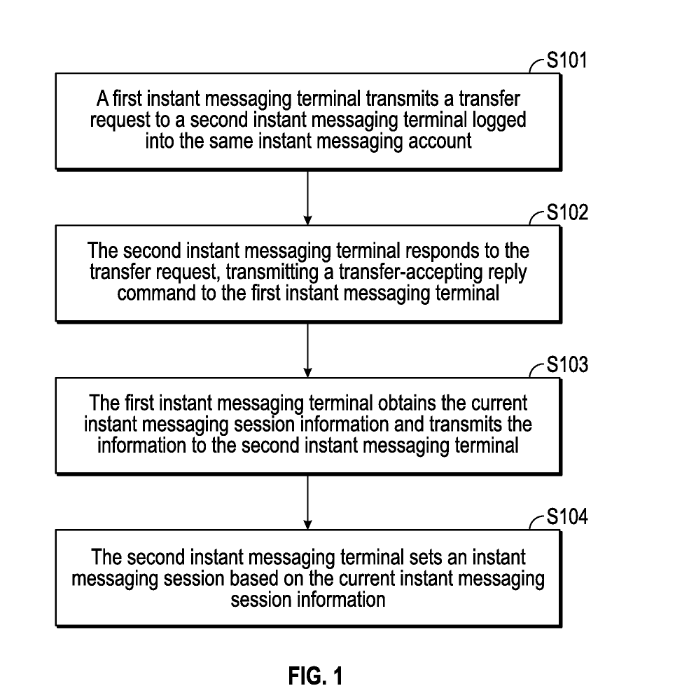

FIG. 1 is a flowchart illustrating the exemplary steps of an instant messaging method, according to a first embodiment of the disclosure. The instant messaging method of the illustrated embodiment can include one or more of the following exemplary steps.

S101: A first instant messaging terminal transmitting a transfer request to a second instant messaging terminal, the first instant messaging terminal and the second instant messaging terminal logged into the same instant messaging account. In particular, the first instant messaging terminal and the second instant messaging terminal can be two network devices on the same local area network (LAN). The terminals can discover each other as terminals logged into the same account on the same network by, for example, having one of the terminals broadcast a discovery message over the LAN. A user can initially be using the instant messaging application on the first instant messaging terminal. He can be carrying out text, voice, or video instant messaging with a friend. He can also just be browsing a friend or group's profile without instant messaging. At this moment, the user may need to switch to using the second instant messaging terminal for some reason. For example, the user may switch from a PC to a mobile phone or tablet PC because he needs to leave the house for some reason. The user can input a command in the instant messaging application on the PC. In response to the user's command, the PC can transmit a transfer request to the mobile phone or tablet PC which has logged into the same instant messaging account and already been discovered on the LAN. The transfer request can request that the current instant messaging session on the PC be transferred to the mobile phone or tablet PC to allow the user to continue the instant messaging session on the second instant messaging terminal.

S102: The second instant messaging terminal can respond to the transfer request, transmitting a transfer-accepting reply command to the first instant messaging terminal. In particular, after the second instant messaging terminal receives the transfer request, a message prompting whether to accept the request can be displayed. The response can be based on a user-input command electing whether to accept the transfer request. If the user elects not to accept the request, the second instant messaging terminal can transmit a command to the first instant messaging terminal rejecting the transfer. The process can then end. If the user chooses to accept the transfer, the second instant messaging terminal can transmit a transfer-accepting reply command to the first instant messaging terminal. In other embodiments, the first instant messaging terminal and the second instant messaging terminal can agree that a transfer request from the other terminal is to be accepted as a default, so that when the second instant messaging terminal receives a transfer request transmitted from the first instant messaging terminal, it can directly respond to the transfer request, transmitting a transfer-accept reply command to the first instant messaging terminal.

S103: After obtaining the transfer-accepting reply from the second instant messaging terminal, the first instant messaging terminal can obtain the current instant messaging session information and transmit the information to the second instant messaging terminal. The current instant messaging terminal session information can include the operating status of the instant messaging application running at the first instant messaging terminal. For example, when instant messaging with an opposite terminal, the current instant messaging session information can include opposite terminal information including, for example, the instant messaging account, IP, nickname, and/or custom remarks associated with the opposite terminal. As another example, if the first instant messaging terminal is not currently instant messaging, but instead is browsing the profile or space of a particular friend or group, the instant messaging session information can include information of the currently-active interface of the instant messaging application at the first instant messaging terminal. Such information can include, for example, a target uniform resource locator (URL). Furthermore, when the first instant messaging terminal is instant messaging with the opposite terminal, the instant messaging session information can also include an instant messaging record of the instant messaging session being carried out with the opposite terminal. The record can include, for example, a chatting record and voice record.

S104: The second instant messaging terminal can set an instant messaging session based on the current instant messaging session information. In particular, the second instant messaging terminal can restore the instant messaging session of the first instant messaging session in the instant messaging application at the second instant messaging terminal based on the current messaging terminal session information. For example, if the user was browsing the profile or space of a particular friend or group at the first instant messaging terminal, the second instant messaging terminal can set the same session based on the instant messaging session information transmitted from the first instant messaging terminal to allow the user to continue to browse the profile or space of the friend or group. If the user was instant messaging a particular friend from the first instant messaging terminal, the second instant messaging terminal can restore the instant messaging session carried out with the opposite terminal based on the opposite terminal information in the current instant messaging session information. For example, if the original text and image instant messaging was carried out using a chat window, the second instant messaging terminal can restore the chat window to resume chatting with the opposite terminal. If video or voice-based conversing was carried out originally, the second instant messaging terminal can restore the video or voice conversing interface to the opposite terminal and activate the camera and microphone of the second instant messaging terminal. Furthermore, the instant messaging session information can also include an instant messaging record of the instant messaging session. The second instant messaging terminal restoring the instant messaging session can provide the previous instant messaging record to inform the user regarding at what point the chat session was stopped so as to facilitate a seamless transfer of the instant messaging session.

In addition, the first instant messaging terminal in this embodiment can transfer the current instant messaging session to the second instant messaging terminal in two different ways: 1) the first instant messaging terminal can maintain the instant messaging connection with the opposite terminal and transmit the current instant messaging session information to the second instant messaging terminal. After the instant messaging session reappears at the second instant messaging terminal, the instant messages received from the opposite terminal can be forwarded to the second instant messaging terminal. At the same time, the user can carry out text, voice, or video input at the second instant messaging terminal and the user-input instant messaging messages can be transmitted to the first instant messaging terminal. The first instant messaging terminal can forward the instant messages obtained from the second instant messaging terminal to the opposite terminal, so that the first instant messaging terminal can serve as an instant message hub between the second instant messaging terminal and the opposite terminal of the first instant messaging terminal. The first instant messaging terminal and the second instant messaging terminal can communicate with each other over the LAN. The first instant messaging terminal and the opposite terminal can communicate over the Internet. Using this method, the second instant messaging terminal does not need to re-initiate the connection to the opposite terminal of the first instant messaging terminal, and thus can have the advantage of being able to reproduce the session instantaneously. 2) After the first instant messaging terminal transmits the current instant messaging session to the second instant messaging terminal, the first instant messaging terminal can terminate the instant messaging connection to the opposite terminal. The second instant messaging terminal can initiate an instant messaging connection with the opposite terminal based on the opposite terminal information in the current instant messaging terminal session information. This allows the second instant messaging terminal to instant message the opposite terminal directly without requiring the continued participation of the first instant messaging terminal.

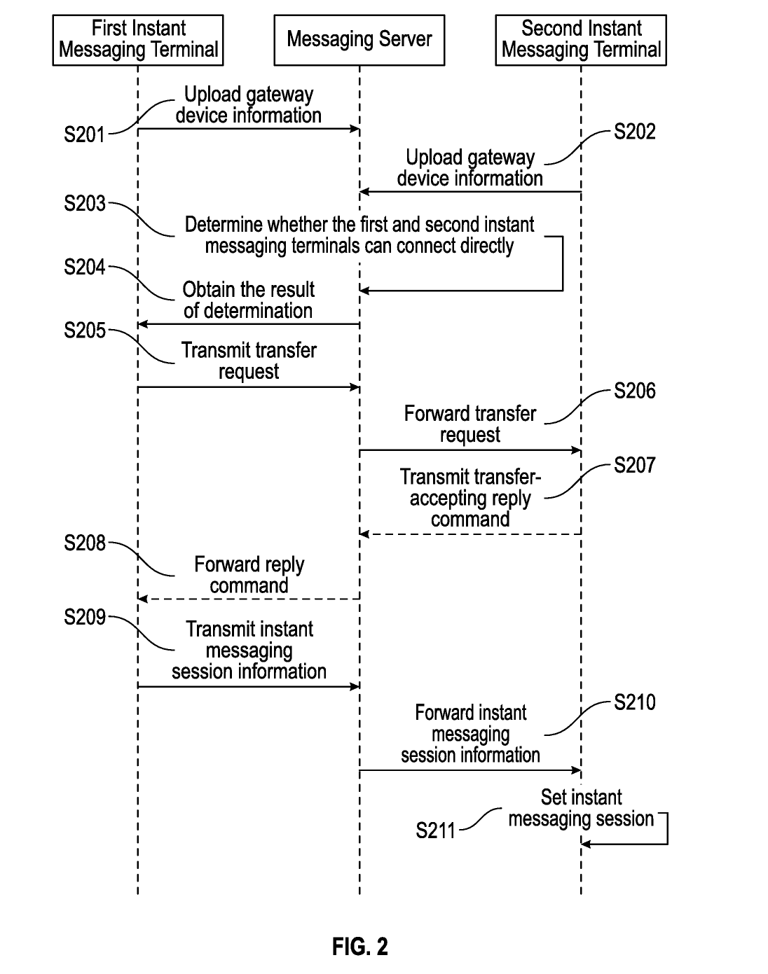

FIG. 2 is a flowchart illustrating the exemplary steps in an instant messaging method, according to a second embodiment of the disclosure. In this embodiment, the first instant messaging terminal and the second instant messaging terminal logged into the same instant messaging account may not be connected to the same LAN, and may discover each other via a server. The instant messaging method in the illustrated embodiment can include the following steps.

S201, S202: the first instant messaging terminal and the second instant messaging terminal can separately upload their respective gateway device information to a messaging server. In operation, the first instant messaging terminal and the second instant messaging terminal can transmit their respective gateway device information to the messaging server on a regular basis after logging into an instant messaging account. The device gateway information can include a unique ID (e.g., a MAC address) of the gateway device (e.g., a router) in the respective LAN or a public IP address.

S203: The messaging server can determine whether the first instant messaging terminal and the second instant messaging terminal can connect to each other directly. In operation, the messaging server can determine whether the two terminals belong to the same LAN based on the gateway device information of each terminal. If they do, it can be determined that they can connect to each other directly.

S204: A first instant messaging terminal can obtain the result of the determination from the messaging server. In operation, when the user needs to transfer an instant messaging session from the first instant messaging terminal to the second instant messaging terminal, the result of the determination regarding whether the first instant messaging terminal and the second instant messaging terminal can connect direct can be obtained from the messaging server first. When the first instant messaging terminal and the second instant messaging terminal can connect to each other directly, steps S101-S104 can be performed. When the first instant messaging terminal and the second instant messaging terminal cannot connect to each other directly, S205 can be performed.

S205: The first instant messaging terminal can transmit, to the messaging server, a transfer request directed to the second instant messaging terminal.

S206: The messaging server can transmit, to the second instant messaging server, the transfer request transmitted from the first instant messaging terminal.

S207: The second instant messaging terminal can respond to the transfer request, transmitting a transfer-accepting reply to the messaging server. In particular, after the second instant messaging terminal receives the transfer request forwarded from the messaging server, a message prompting whether to accept the request can be displayed. The response can be based on a user-input command electing whether to accept the transfer request. If the user elects not to accept the request, the second instant messaging terminal can transmit, to the messaging server, a reply command rejecting the transfer. The process can end after the messaging server forwards the reply command to the first instant messaging server. If the user elects to accept the transfer, the second instant messaging terminal can transmit to the messaging server a reply command accepting the transfer. In other embodiments, the first instant messaging terminal and the second instant messaging terminal can agree that a transfer request from the other terminal is to be accepted as a default, so that when the second instant messaging terminal receives a transfer request transmitted from the first instant messaging terminal, it can directly respond to the transfer request, transmitting a transfer-accept reply command to the first instant messaging terminal.

S208: The messaging server can forward the transfer-accepting reply command to the first instant messaging terminal.

S209: The first instant messaging terminal can transmit instant messaging session information to the messaging server. The instant messaging terminal session information can include the operating status of the instant messaging application running at the first instant messaging terminal. For example, when instant messaging with an opposite terminal, the instant messaging session information can include opposite terminal information including, for example, the instant messaging account, IP, nickname, and/or custom remarks associated with the opposite terminal. As another example, if the first instant messaging terminal is not currently instant messaging, but instead is browsing the profile or space of a particular friend or group, the instant messaging session information can include information of the currently-active interface of the instant messaging application at the first instant messaging terminal. Such information can include, for example, a target uniform resource locator (URL). Furthermore, when the first instant messaging terminal is instant messaging with the opposite terminal, the instant messaging session information can also include an instant messaging record of the instant messaging session being carried out with the opposite terminal. The record can include, for example, a chatting record and voice record.

S210: The messaging server can forward, to the second instant messaging terminal, the instant messaging session information of the first instant messaging terminal.

S211: The second instant messaging terminal can set an instant messaging session based on the instant messaging session information. In particular, the second instant messaging terminal can restore the instant messaging session of the first instant messaging session in the instant messaging application at the second instant messaging terminal based on the messaging terminal session information. For example, if the user was browsing the profile or space of a particular friend or group at the first instant messaging terminal, the second instant messaging terminal can set the same session based on the instant messaging session information transmitted from the first instant messaging terminal, to allow the user to continue to browse the profile or space of the friend or group. If the user was instant messaging a particular friend from the first instant messaging terminal, the second instant messaging terminal can restore the instant messaging session carried out with the opposite terminal based on the opposite terminal information in the received instant messaging session information. For example, if the original text and image instant messaging was carried out using a chat window, the second instant messaging terminal can restore the chat window to resume chatting with the opposite terminal. If video or voice-based conversing was carried out originally, the second instant messaging terminal can restore the video or voice conversing interface to the opposite terminal and activate the camera and microphone of the second instant messaging terminal. Furthermore, the instant messaging session information can also include an instant messaging record of the instant messaging session. The second instant messaging terminal restoring the instant messaging session can provide the previous instant messaging record to inform the user regarding at what point the chat session was stopped so as to facilitate a seamless transfer of the instant messaging session.

In particular, in this embodiment, the first instant messaging terminal can transfer the current instant messaging session to the second instant messaging terminal using either one of the two methods disclosed in the first embodiment, the second method being the preferred choice of the two.

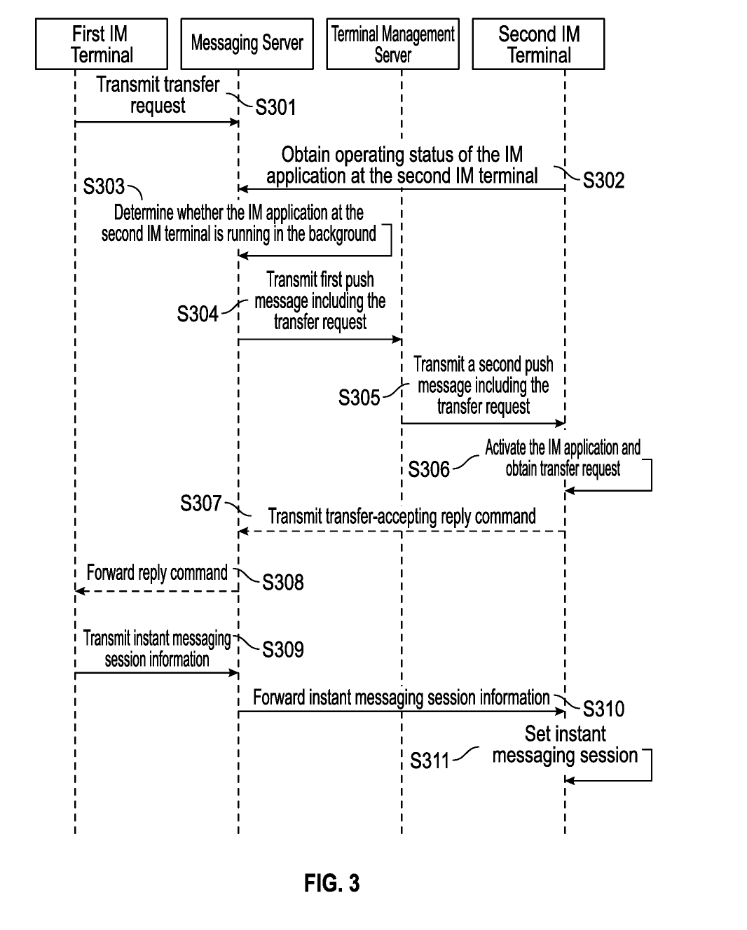

FIG. 3 is a flowchart illustrating exemplary steps in an instant messaging method, according to a third embodiment of the disclosure. The instant messaging method of the illustrated embodiment can include at least the following steps.

S301: The messaging server can obtain a transfer request transmitted from the first instant messaging terminal to the second instant messaging terminal. In particular, because both the first instant messaging terminal and the second instant messaging terminal have logged into the same instant messaging account, any transfer request transmitted from the first instant messaging terminal to the second instant messaging terminal through the instant messaging application can be obtained by the messaging server. In this embodiment, the instant messaging application at the second instant messaging terminal can run in the background. Thus, it may not be able to receive the transfer request from the first instant messaging terminal directly and, instead, may require the messaging server to obtain and forward the transfer request.

S302: The messaging server can obtain the operating status of the instant messaging application at the second instant messaging terminal. In operation, the second instant messaging terminal can transmit the operating status of its instant messaging application to the messaging server either on a regular basis or when there is a change to the operating status, to notify the messaging server regarding its latest operating status.

S303: The messaging server can determine whether the instant messaging application at the second instant messaging terminal is running in the background. In operation, after obtaining the transfer request transmitted from the first instant messaging terminal to the second instant messaging terminal, the messaging server can determine whether the instant messaging application at the second instant messaging terminal is running in the background based on the latest operating status of the instant messaging application uploaded from the second instant messaging terminal. When it is determined that the instant messaging application at the second instant messaging terminal is running in the background, a transfer of the instant messaging session can be carried out according to the processes described in the previous two embodiments. For example, whether the first instant messaging terminal and the second instant messaging terminal can connect to each other directly can be determined based on the gateway device information of the first instant messaging terminal and the second instant messaging terminal. If direct connection is possible, the transfer request can arrive at the second instant messaging terminal directly and the subsequent process of the first embodiment can be carried out. If the first instant messaging terminal and the second instant messaging terminal cannot connect directly, the messaging server can forward the received transfer request to the second instant messaging terminal where subsequent processes can be carried out. When it is determined that the instant messaging application at the second instant messaging terminal is running in the background, 5304 can be carried out.

S304: The messaging server can transmit, to a terminal management server associated with the second instant messaging terminal, a first push message including the transfer request. The terminal management server associated with the second instant messaging terminal can be, for example, an Apple terminal management server. The messaging server can transmit the first push message including the transfer request to the Apple terminal management server, requesting the Apple terminal management server to activate the second instant messaging terminal under its management. The second instant messaging terminal here can be, for example, an iPhone and/or iPad (Apple's smartphone and tablet PC, respectively, both using the iOS system).

S305: The terminal management server associated with the second instant messaging terminal can transmit a second push message including the transfer request to the second instant messaging terminal based on the first push message transmitted from the messaging server.

S306: The second instant messaging terminal can activate the instant messaging application in response to the second push message and obtain the transfer request in the second push message.

S307-S311 can be the same as S207-S211 in the second embodiment described above.

This embodiment can resolve the problem that the second instant messaging terminal may not receive the transfer request transmitted from the first instant messaging terminal when the instant messaging application at the second instant messaging terminal is running in the background.

Another embodiment of the disclosure discloses a non-transitory computer-readable storage medium, that stores one or more programs, which when executed, can perform part or all of the steps of the instant messaging methods of the above-described embodiments.

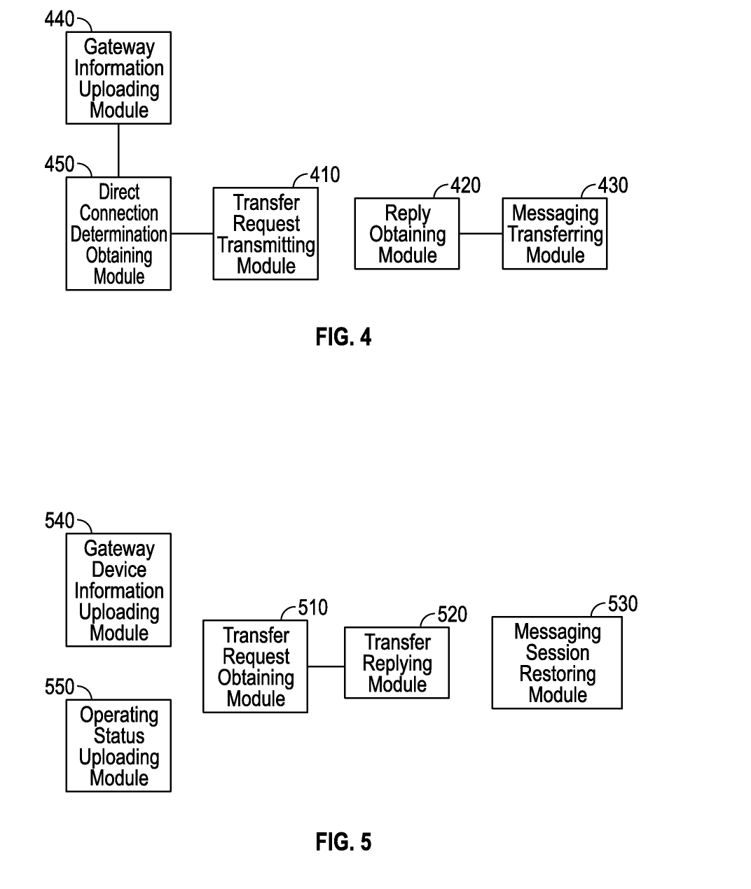

FIG. 4 is a block diagram illustrating the exemplary structure of a first instant messaging terminal, according to an embodiment of the disclosure. The first instant messaging terminal in this embodiment can be a PC, mobile phone, tablet PC, smartphone, e-reader, laptop PC, in-car terminal, or any other network-enabled device. The first instant messaging terminal in the illustrated embodiment can include at least a transfer request transmitting module 410, a reply obtaining module 420, and a messaging transferring module 430.

The transfer request transmitting module 410 can transmit a transfer request to the second instant messaging terminal logged into the same instant messaging account. In particular, the transfer request transmitting module 410 can transmit the transfer request to the second instant messaging terminal either directly or through a messaging server. For example, when the first instant messaging terminal and the second instant messaging terminal have discovered each other on the same LAN, the transfer request transmitting module 410 can transmit the transfer request directly to the second instant messaging terminal. Alternatively, the first instant messaging terminal can obtain from a messaging server the result of the determining of whether a direct connection to the second instant messaging terminal can be established. Based on the result, it can be determined whether the transfer request transmitting module 410 can transmit the transfer request to the second instant messaging terminal directly or through a messaging server.

The reply obtaining module 420 can obtain a reply command transmitted from the second instant messaging terminal. In particular, after the second instant messaging terminal receives the transfer request transmitted from the transfer request transmitting module 410, a message prompting whether to accept the request can be displayed. The response can be based on a user-input command electing whether to accept the transfer request. If the user elects not to accept the request, the second instant messaging terminal can transmit a command to the first instant messaging terminal rejecting the transfer. The process can then end. If the user elects to accept the transfer, the second instant messaging terminal can transmit a transfer-accepting reply command to the first instant messaging terminal. The reply obtaining module 420 can then obtain the transfer-accepting reply command from the second instant messaging terminal. In other embodiments, the first instant messaging terminal and the second instant messaging terminal can agree that a transfer request from the other terminal is to be accepted as a default, so that when the second instant messaging terminal receives a transfer request transmitted from the transfer request transmitting module 410, it can directly respond to the transfer request, transmitting a transfer-accept reply command to the first instant messaging terminal.

The messaging transferring module 430 can obtain the current instant messaging session information and transmit the information to the second instant messaging terminal to allow the second instant messaging terminal to set the instant messaging session based on the current instant messaging session information, after the reply obtaining module obtains the transfer-accepting reply command from the second instant messaging terminal. The current instant messaging terminal session information can include the operating status information of the instant messaging application running at the first instant messaging terminal. For example, when instant messaging with an opposite terminal, the instant messaging session information can include opposite terminal information including, for example, the instant messaging account, IP, nickname, and/or custom remarks associated with the opposite terminal. As another example, if the first instant messaging terminal is not currently instant messaging, but instead is browsing the profile or space of a particular friend or group, the instant messaging session information can include information of the currently-active interface of the instant messaging application at the first instant messaging terminal. Such information can include, for example, a target uniform resource locator (URL). Furthermore, when the first instant messaging terminal is instant messaging with the opposite terminal, the instant messaging session information can also include an instant messaging record of the instant messaging session being carried out with the opposite terminal. The record can include, for example, a chatting record and voice record.

Optionally, the messaging transferring module 430 of the first instant messaging terminal in this embodiment can also include the following exemplary units.

A first messaging transferring unit can forward the instant messaging information received from the opposite terminal to the second instant messaging terminal and forward the instant messaging information received from the second instant messaging terminal to the opposite terminal. In operation, after the messaging transferring module 430 transmits the instant messaging session information to the second instant messaging terminal, the first messaging transferring unit can maintain its instant messaging connection with the opposite terminal. The first messaging transferring unit can forward the received instant messaging information to the second instant messaging terminal. At the same time, the user can carry out text, voice, or video input at the second instant messaging terminal and transmit the instant messaging information input by the user to the first instant messaging terminal. The first messaging transferring unit can forward the instant message information obtained from the second instant messaging terminal to the opposite terminal, so that the first messaging transferring unit can serve as a hub for the instant messages between the second instant messaging terminal and the opposite terminal of the first instant messaging terminal. The first messaging transferring unit and the second instant messaging terminal can communicate with each other over the LAN. The first messaging transferring unit and the opposite terminal can communicate over the Internet. With this method, the second instant messaging terminal does not need to re-initiate the connection to the opposite terminal of the first instant messaging terminal, and thus can have the advantage of being able to reproduce the session instantaneously.

Optionally, the first instant messaging terminal in this embodiment can further include the following modules.

A gateway information uploading module 440 that can upload the gateway device information of the first instant messaging terminal to the messaging server. In particular, the device gateway information of the first instant messaging terminal can include a unique ID (e.g., a MAC address) of the gateway device (e.g., a router) in the respective LAN or a public IP address.

A direct connection determination obtaining module 450 that can obtain the result of a determination made by the messaging server, based on the gateway device information of the first instant messaging terminal and the second instant messaging terminal, regarding whether the first instant messaging terminal and the second instant messaging terminal can connect directly to each other. In operation, the messaging server can determine whether the two terminals belong to the same LAN. If they do, it can be determined that they can connect to each other directly. The direct connection determination obtaining module 450 can obtain from the messaging server the result of the determination of whether the first instant messaging terminal and the second instant messaging terminal can connect directly. When the first instant messaging terminal and the second instant messaging terminal can connect directly, the transfer request transmitting module 410 can transmit the transfer request directly to the second instant messaging terminal. The messaging transferring module 430 can transmit the current instant messaging session information directly to the second instant messaging terminal. When the first instant messaging terminal and the second instant messaging terminal cannot connect directly, the transfer request transmitting module 410 can transmit the transfer request to the second instant messaging terminal through the messaging server. The messaging transferring module 430 can transmit the current instant messaging session information to the second instant messaging terminal through the messaging server.

FIG. 5 is a block diagram illustrating the exemplary structure of the second instant messaging terminal, according to an embodiment of the disclosure. The second instant messaging terminal can be a PC, mobile phone, tablet PC, smartphone, e-reader, laptop computer, in-car terminal, or any other network-enabled device. The second instant messaging terminal in the illustrated embodiment can include at least a transfer request obtaining module 510, a transfer replying module 520, and a messaging session restoring module 530.

The transfer request obtaining module 510 can obtain a transfer request transmitted from a first instant messaging terminal logged into the same instant messaging account. In particular, the messaging session restoring module 530 can obtain the instant messaging session information from the first instant messaging terminal either directly or through a messaging server.

The transfer replying module 520 can respond to the transfer request, transmitting a transfer-accepting reply command to the first instant messaging terminal. In particular, after the transfer request obtaining module 510 receives the transfer request, a message prompting whether to accept the request can be displayed. The transfer replying module 520 can respond to the transfer request based on a user-input command electing whether to accept the transfer request. If the user elects not to accept the request, the transfer replying module 520 can transmit a command to the first instant messaging terminal rejecting the transfer. If the user elects to accept the transfer, the transfer replying module 520 can transmit a transfer-accepting reply command to the first instant messaging terminal. In other embodiments, the first instant messaging terminal and the second instant messaging terminal can agree that a transfer request from the other terminal is to be accepted as a default, so that when the transfer request obtaining module 510 receives a transfer request transmitted from the first instant messaging terminal, it can directly respond to the transfer request, transmitting a transfer-accept reply command to the first instant messaging terminal. Furthermore, when the messaging session restoring module 530 obtains the instant messaging session information directly from the first instant messaging terminal, the transfer replying module 520 can transmit the transfer-accepting reply command directly to the first instant messaging terminal. When the messaging session restoring module 530 obtains the instant messaging session information through the messaging server, the transfer replying module 520 can transmit the transfer-accepting reply command to the first instant messaging terminal through the messaging server.

The messaging session restoring module 530 can obtain the current instant messaging session information from the first instant messaging terminal and set an instant messaging session based on the instant messaging session information. In particular, the messaging session restoring module 530 can restore the instant messaging session of the first instant messaging terminal in a local instant messaging application based on the instant messaging session information.

For example, if the user was browsing the profile or space of a particular friend or group at the first instant messaging terminal, the messaging session restoring module 530 can set the same session based on the instant messaging session information transmitted from the first instant messaging terminal, to allow the user to continue to browse the profile or space of the friend or group. If the user was instant messaging a particular friend at the first instant messaging terminal, the messaging session restoring module 530 can restore the instant messaging session carried out with the opposite terminal based on the opposite terminal information in the received instant messaging session information. For example, if the original text and image instant messaging was done using a chat window, the messaging session restoring module 530 can restore the chat window chatting to resume chatting with the opposite terminal. If video or voice-based conversing was carried out originally, the messaging session restoring module 530 can restore the video or voice conversing interface to the opposite terminal and activate the camera and microphone at the second instant messaging terminal. Furthermore, the instant messaging session information can also include a current instant messaging record. The messaging session restoring module 530 restoring the instant messaging session can provide the previous instant messaging record to inform the user regarding at what point the chat session was stopped so as to facilitate a seamless transfer of the instant messaging session.

In addition, the messaging session restoring module 530 of the second instant messaging terminal in this embodiment can further include the following exemplary units.

A first messaging session restoring unit can obtain, from the first instant messaging terminal, the instant messaging information transmitted from the opposite terminal of the first instant messaging terminal, and transmit instant messaging information to the first instant messaging terminal to allow the first instant messaging terminal to forward the instant messaging information transmitted from the second instant messaging terminal to the opposite terminal.

In operation, the first instant messaging terminal can maintain an instant messaging connection with the opposite terminal. After the messaging session restoring module 530 restores the instant messaging session based on the instant messaging session information obtained from the first instant messaging terminal, the first messaging session restoring unit can obtain the instant messaging information transmitted from the first instant messaging terminal to the opposite terminal. At the same time, a user can carry out text, voice, or video input at the second instant messaging terminal. The first messaging session restoring unit can transmit the user-input instant messaging information to the first instant messaging terminal. The first instant messaging terminal can forward the instant messaging information obtained from the second instant messaging terminal to the opposite terminal, so that the first instant messaging terminal can serve as a hub for the instant message information transmitted between the second instant messaging terminal and the opposite terminal of the first instant messaging terminal. The first instant messaging terminal and the second instant messaging terminal can communicate with each other over the LAN. The first instant messaging terminal and the opposite terminal can communicate over the Internet. Using this method, the second instant messaging terminal does not need to re-initiate a connection to the opposite terminal of the first instant messaging terminal and can, thus, have the advantage of being able to reproduce the session instantaneously.

A second messaging session restoring unit can establish an instant messaging connection with the opposite terminal based on the opposite terminal information in the instant messaging session information. In operation, after the first instant messaging terminal transmits instant messaging session information to the second instant messaging terminal, the first instant messaging terminal can terminate the instant messaging connection with the opposite terminal. The second messaging session restoring unit can establish an instant messaging connection with the opposite terminal based on the opposite terminal information in the instant messaging session information. As such, the second instant messaging terminal can instant message the opposite terminal directly without the participation of the first instant messaging terminal.

Optionally, the second instant messaging terminal in this embodiment can further include the following exemplary modules.

A gateway device information uploading module 540 can upload the gateway device information of the second instant messaging terminal to a messaging server, to allow the messaging server to determine, based on the gateway device information of the second instant messaging terminal and the first instant messaging terminal, whether the second instant messaging terminal and the first instant messaging terminal can connect directly to each other. The messaging server can determine whether two terminals belong to the same LAN based on each terminal's gateway device information. If they do, it can then be determined that the two terminals can connect directly to each other. When the second instant messaging terminal and the first instant messaging terminal can connect directly, the transfer request obtaining module 510 can obtain the transfer request directly from the first instant messaging terminal. The messaging session restoring module 530 can obtain the instant messaging session information directly from the first instant messaging terminal. When the second instant messaging terminal and the first instant messaging terminal cannot connect directly, the transfer request obtaining module 510 can obtain the transfer request transmitted from the first instant messaging terminal through the messaging server. The messaging session restoring module 530 can obtain the instant messaging session information through the messaging server.

Optionally, the second instant messaging terminal can also include the following exemplary modules.

An operating status uploading module 550 can transmit an operating status of the instant messaging application to the messaging server, to allow the messaging terminal to determine whether the instant messaging application at the second messaging terminal is running in the background. In operation, the operating status uploading module 550 can transmit the operating status information of its instant messaging application to the messaging server on a regularly basis or when there is a change to the operating status of the instant messaging application, to notify the messaging server about the latest operating status.

The transfer request obtaining module 510 can further include the following exemplary units.

A push message obtaining unit can obtain a second push message transmitted from a terminal management server based on a first push message transmitted from the messaging server to the terminal management server, the first push message and the second push message both including the transfer request transmitted from the first instant messaging terminal. In operation, the terminal management server associated with the second instant messaging terminal can be an Apple terminal management server. The messaging server can transmit the first push message including the transfer request to the Apple terminal management server, requesting the Apple terminal management server to activate the second instant messaging terminal under its management. Then, the terminal management server associated with the second instant messaging terminal can transmit a second push messaging including the transfer request to the second instant messaging terminal based on the first push message transmitted from the messaging server. The push messaging obtaining unit can obtain the second push message transmitted from the terminal management server. The second instant messaging terminal in this embodiment can be, for example, an iPhone and/or iPad.

An activating unit can activate the instant messaging application based on the second push message, and obtain the transfer request in the second push message.

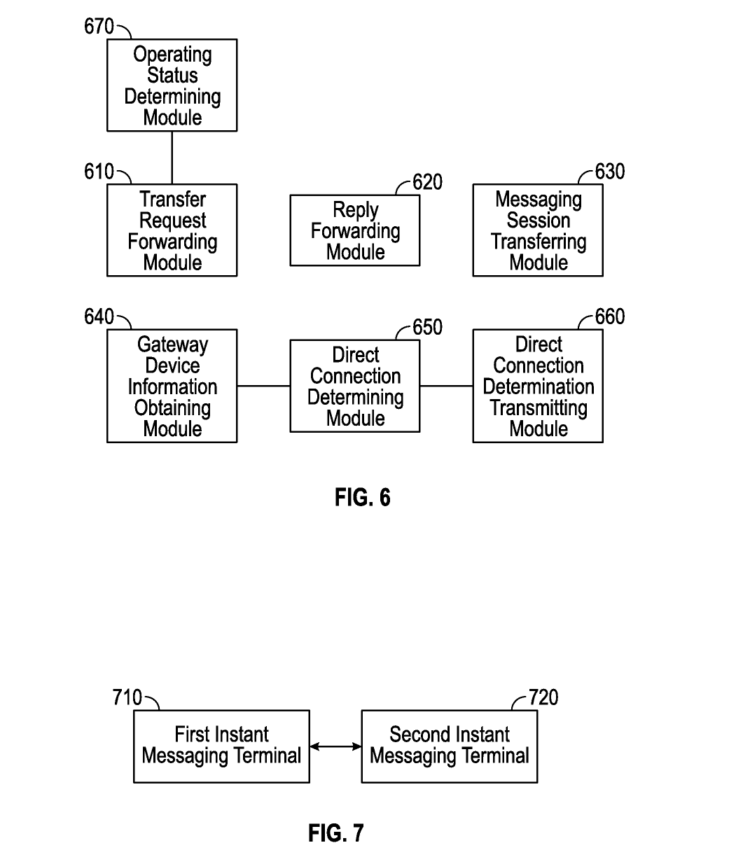

FIG. 6 is a block diagram illustrating the exemplary structure diagram of the messaging server, according to an embodiment of the disclosure. The messaging server in the illustrated embodiment can include a transfer request forwarding module 610, a reply forwarding module 620, and a messaging session transferring module 630.

The transfer request forwarding module 610 can obtain a transfer request transmitted from a first instant messaging terminal to a second instant messaging terminal logged into a same instant messaging account, and forward the transfer request to the second instant messaging terminal.

The reply forwarding module 620 can obtain a transfer-accepting reply command transmitted from the second instant messaging terminal in response to the transfer request, and forward the reply command to the first instant messaging terminal.

The messaging session transferring module can obtain current instant messaging session information of the first instant messaging terminal transmitted from the first instant messaging terminal, and forward the instant messaging session information to the second instant messaging terminal, to allow the second instant messaging terminal to set an instant messaging session based on the instant messaging session information.

Optionally, the messaging server of this embodiment can also include the following exemplary modules.

A gateway device information obtaining module 640 that can obtain gateway device information uploaded from the first instant messaging terminal and the second instant messaging terminal. In operation, the first instant messaging terminal and the second instant messaging terminal can transmit their respective gateway device information to the messaging server via the instant messaging application on a regular basis after logging into the instant messaging account. The device gateway information can include a unique ID (e.g., a MAC address) of the gateway device (e.g., a router) in the respective LAN or a public IP address.

A direct connection determining module 650 can determine whether the first instant messaging terminal and the second instant messaging terminal can connect directly to each other based on the gateway device information of the first instant messaging terminal and the second instant messaging terminal. In operation, the direct connection determining module 650 can determine, based on each terminal's gateway device information, whether the two terminals belong to the same LAN. If they do, it can be determined that the two terminals can connect directly to each other.

A direct connection determination transmitting module 660 that can transmit, to the first instant messaging terminal, a result of the determination of whether the first instant messaging terminal and the second instant messaging terminal can connect directly to each other. This can allow the first instant messaging terminal to transmit a transfer request to the second instant messaging terminal either directly or through the messaging server.

Optionally, the messaging server in this embodiment can further include the following exemplary modules.

An operating status determining module 670 can obtain operating status information of the instant messaging application at the second instant messaging terminal, and determine whether the instant messaging application at the second instant messaging terminal is running in the background based on the operating status information of the second instant messaging terminal.

The transfer request forwarding module 610 can include the following units.

A transfer request obtaining unit can obtain the transfer request directed to the second instant messaging terminal and transmitted from the first instant messaging terminal.

A push message transmitting unit can transmit a first push message including the transfer request to a terminal managing server, when the operating status determining module 670 determines that the instant messaging application at the second instant messaging terminal is running in the background, to allow the terminal management server to transmit a second push message including the transfer request to the second instant messaging terminal based on the first push message, and thus allowing the second instant messaging terminal to activate its instant messaging application based on the second push message and obtain the transfer request. The terminal management server associated with the second instant messaging terminal can be an Apple terminal management server. The push message transmitting unit can transmit the first push message including the transfer request to the Apple terminal management server based on the transfer request directed to the second instant messaging terminal and transmitted from the first instant messaging terminal, requesting the Apple terminal management server to activate the second instant messaging terminal under its management. Then, the Apple terminal management server can transmit a second push message including the transfer request to the second instant messaging terminal based on the first push message. Finally, the second instant messaging terminal can activate the instant messaging application based on the second push message and obtain the transfer request in the second push message. The second instant messaging terminal can be, for example, an iPhone and/or iPad.

FIG. 7 is a block diagram illustrating exemplary structure of an instant messaging system, according to the first embodiment of the disclosure. The instant messaging system in the illustrated embodiment can include a first instant messaging terminal 710 and a second instant messaging terminal 720.

The first instant messaging terminal 710 can be the first instant messaging terminal described above in view of FIG. 4, for transmitting a transfer request to the second instant messaging terminal 720 logged into the same instant messaging application. After receiving a transfer-accepting reply command from the second instant messaging terminal 720, the first instant messaging terminal can transmit the current instant messaging session information to the second instant messaging terminal 720.

The second instant messaging terminal 720 can be the second instant messaging terminal described above in view of FIG. 5, for obtaining a transfer request from the first instant messaging terminal 710, transmitting a transfer-accepting reply command to the first instant messaging terminal, obtaining the current instant messaging session information of the first instant messaging terminal 710, and setting an instant messaging session based on the instant messaging session information.

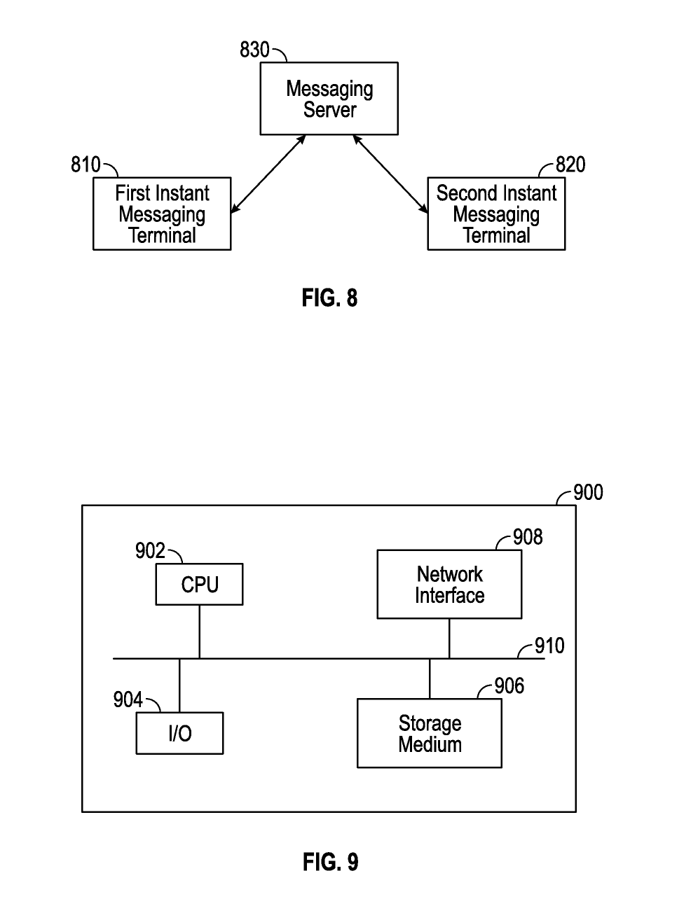

FIG. 8 is a block diagram illustrating the exemplary structure of the instant messaging system in the second embodiment of the disclosure. The instant messaging system in the illustrated embodiment can include, for example, a first instant messaging terminal 810, a second instant messaging terminal 820, and a messaging server 830.

The first instant messaging terminal 810 can transmit a transfer request to the second instant messaging terminal 820 through the messaging server 830, both terminals logged into the same account. After obtaining a transfer-accepting reply command through the messaging server 830, the first instant messaging terminal can transmit the current instant messaging session information to the second instant messaging terminal 820 through the messaging server 830.

The second instant messaging terminal 820 can obtain the transfer request transmitted from the first instant messaging terminal 810 through the messaging server 830. The second instant messaging terminal can transmit a transfer-accepting reply command to the first instant messaging terminal 810 through the messaging server 830. The second instant messaging terminal can obtain the current instant messaging session information of the first instant messaging terminal 810 and set an instant messaging session based on the instant messaging session information.

The messaging server 830 can obtain the transfer request transmitted from the first instant messaging terminal 810 and forward the transfer request to the second instant messaging terminal 820, and obtain the current instant messaging session information of the first instant messaging terminal 810 and forward the current instant messaging session information to the second instant messaging terminal 820.

The embodiments of the disclosure can transmit the instant messaging session information from an originating terminal to a receiving terminal, thereby facilitating an effective transfer of an instant messaging session to allow the user to be able to conveniently continue the previous instant messaging session after switching terminals.

Based on the above-described embodiments, a person skilled in the art can understand that parts of or the whole process described in each of the above embodiments can be performed by hardware in accordance with instructions from one or more computer programs. The one or more computer programs can be stored in a non-transitory readable medium, and when executed, perform the processes described in these embodiments. The non-transitory computer readable medium can be a floppy disk, CD, read-only memory (ROM), or random access memory (RAM).

In some embodiments, one or more of the modules and/or units in FIGS. 4-8 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer- readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The non-transitory computer readable storage medium can be part of a computing system serving as one of the terminals or servers. FIG. 9 illustrates exemplary common components of one such computing system. As illustrated, the system 900 can include a central processing unit (CPU) 902, I/O components 904 including, but not limited to one or more of display, keypad, touch screen, speaker, and microphone, storage medium 906 such as the ones listed in the last paragraph, and network interface 908, all of which can be connected to each other through a system bus 910. The storage medium 906 can include the modules of FIGS. 4-8 if the system is a terminal or server in one of the embodiments discussed above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

what is claimed is:

1. A first instant messaging terminal, comprising:
a transfer request transmitting module that transmits a transfer request to a second instant messaging terminal, the first and second instant messaging terminals logged into the same instant messaging account;
a reply obtaining module that obtains a transfer-accepting reply command transmitted from the second instant messaging terminal; and
a messaging transferring module that, when the reply obtaining module obtains the transfer-accepting reply command from the second instant messaging terminal, obtains current instant messaging session information and transmits the current instant messaging session information to the second instant messaging terminal to allow the second instant messaging terminal to set an instant messaging session based on the current instant messaging session information.

2. The first instant messaging terminal of claim 1, wherein the instant messaging session information comprises opposite terminal information associated with the first instant messaging terminal.

3. The first instant messaging terminal of claim 2, wherein the messaging transferring module comprises:
a first message transferring unit that transfers instant message information obtained from an opposite terminal of the first instant messaging terminal to the second instant messaging terminal, and transfers instant message information obtained from the second instant messaging terminal to the opposite terminal.

4. The first instant messaging terminal of claim 3, wherein the first message transferring unit connects to the second instant messaging terminal through a first network, the first message transferring unit connects to the opposite terminal through a second network.

5. The first instant messaging terminal of claim 1, wherein the instant messaging terminal session information comprises an instant messaging record of a current instant messaging session at the first instant messaging terminal.

6. The first instant messaging terminal of claim 1, wherein the transfer request transmitting module is configured to transmit a transfer request to the second instant messaging terminal either directly or through a messaging server; and
the messaging transferring module is configured to transmit the current instant messaging session information to the second instant messaging terminal either directly or through the messaging server.

7. The first instant messaging terminal of claim 1, wherein the first instant messaging terminal comprises:
a gateway device information uploading module that uploads gateway device information to a messaging server;
a direct connection determination obtaining module that obtains a result of the messaging server's determination of whether the first instant messaging terminal and the second instant messaging terminal can connect to each other directly based on the gateway device information of the first instant messaging terminal and the second instant messaging terminal;
when the first instant messaging terminal and the second first instant messaging terminal can connect directly to each other, the transfer request transmitting module transmits the transfer request directly to the second instant messaging terminal, the messaging transferring module transmits the current instant messaging session information directly to the second instant messaging terminal;
when the first instant messaging terminal and the second instant messaging terminal cannot connect directly, the transfer request transmitting module transmits the transfer request to the second instant messaging terminal through the messaging server, the messaging transferring module transmits the current instant messaging session information to the second instant messaging terminal through the messaging server.

8. A second instant messaging terminal, comprising:
a transfer request obtaining module that obtains a transfer request from a first instant messaging terminal, the first instant messaging terminal and the second instant messaging terminal logged into a same instant messaging account;
a transfer replying module that responds to the transfer request, transmitting to the first instant messaging terminal a transfer-accepting reply command;
a messaging session restoring module that obtains, from the first instant messaging terminal, current instant messaging session information and sets an instant messaging session based on the current instant messaging session information.

9. The second instant messaging terminal of claim 8, wherein the instant messaging session information comprising opposite terminal information associated with the first instant messaging terminal; and
wherein the messaging session restoring module comprises:
a first messaging session restoring unit that obtains, from the first instant messaging terminal, instant message information transmitted from an opposite terminal of the first instant messaging terminal, and transmits instant message information to the first instant messaging terminal to allow the first instant messaging terminal to forward the instant message information to the opposite terminal; or
a second messaging session restoring unit that establishes an instant messaging connection to the opposite terminal based on the opposite terminal information in the current instant messaging session information.

10. The second instant messaging terminal of claim 8, wherein the current instant messaging session information comprises an instant message record of an instant messaging session at the first instant messaging terminal.

11. The second instant messaging terminal of claim 8, wherein the transfer request obtaining module obtains, from the first instant messaging terminal, the transfer request transmitted from the first instant messaging terminal either directly or through a messaging server;
the messaging session restoring module obtains, from the first instant messaging terminal, the current instant messaging session information, either directly or through the messaging server.

12. The second instant messaging terminal of claim 8, comprising:
a gateway device information uploading module that uploads gateway device information of the second instant messaging terminal to a messaging server, to allow the messaging server to determine, based on the gateway device information of the second instant messaging terminal and the first instant messaging terminal, whether the second instant messaging terminal and the first instant messaging terminal can connect directly to each other;
when the second instant messaging terminal and the first instant messaging terminal can connect directly, the transfer request obtaining module obtains the transfer request directly from the first instant messaging terminal, the messaging session restoring module obtains the current instant messaging session information directly from the first instant messaging terminal;
when the second instant messaging terminal and the first instant messaging terminal cannot connect directly, the transfer request obtaining module obtains the transfer request transmitted from the first instant messaging terminal through the messaging server, the messaging session restoring module obtains the current instant messaging session information through the messaging server.

13. The second instant messaging terminal of claim 8, comprising:
an operating status uploading module that transmits an operating status of the instant messaging application to the messaging server to allow the messaging server to determine whether the instant messaging application at the second messaging terminal is running in the background; and
wherein the transfer request obtaining module comprises:
a push message obtaining unit that obtains a second push message transmitted from a terminal management server based on a first push message transmitted from the messaging server to the terminal management server, the first push message and the second push message both comprise the transfer request transmitted from the first instant messaging terminal;
an activating unit that activates the instant messaging application based on the second push message, and obtains the transfer request in the second push message.

14. An instant message server, comprising:
a transfer request forwarding module that obtains a transfer request transmitted from a first instant messaging terminal to a second instant messaging terminal, the first instant messaging terminal and second instant messaging terminal logged into a same instant messaging account, and forwards the transfer request to the second instant messaging terminal;
a reply forwarding module that obtains a transfer-accepting reply command transmitted from the second instant messaging terminal in response to the transfer request, and forwards the reply command to the first instant messaging terminal; and
a messaging session transferring module that obtains current instant messaging session information of the first instant messaging terminal transmitted from the first instant messaging terminal, and forwards the current instant messaging session information to the second instant messaging terminal to allow the second instant messaging terminal to set an instant messaging session based on the current instant messaging session information.

15. The instant messaging server of claim 14, wherein the messaging server comprises:
a gateway device information obtaining module that obtains gateway device information uploaded from the first instant messaging terminal and the second instant messaging terminal;
a direct connection determining module that determines whether the first instant messaging terminal and the second instant messaging terminal can connect directly with each other based on the gateway device information of the first instant messaging terminal and the second instant messaging terminal; and
a direct connection determination transmitting module that transmits, to the first instant messaging terminal, a result of the determination of whether the first instant messaging terminal and the second instant messaging terminal can connect directly.

16. The messaging server of claim 14, comprising:
an operating status determining module that obtains operating status information of an instant messaging application at the second instant messaging terminal, and determines whether the instant messaging application at the second instant messaging terminal is running in the background based on the operating status information of the second instant messaging terminal; and
wherein the transfer request forwarding module comprises:
a transfer request obtaining unit that obtains the transfer request directed to the second instant messaging terminal and transmitted from the first instant messaging terminal;
a push message transmitting unit that, when the operating status determining module determines that the instant messaging application at the second instant messaging terminal is running in the background, transmits a first push message including the transfer request to a terminal management server to allow the terminal management server to transmit a second push message including the transfer request to the second instant messaging terminal based on the first push message, thus allowing the second instant messaging terminal to activate its instant messaging application based on the second push message and obtain the transfer request.
